(19) United States
(12) Patent Application Publication
(10) Pub. No.: US 2009/0224454 A1
(43) Pub. Date: Sep. 10, 2009

(54) Vise quick-release structure for miter saw

(75) Inventors: Chia-Sheng Liu, Chiayi County (TW); Yi-Li Cheng, Taichung County (TW)

Correspondence Address: BACON & THOMAS, PLLC, 625 SLATERS LANE, FOURTH FLOOR, ALEXANDRIA, VA, 22314-1176, US

(73) Assignee: DURQ MACHINERY CORP., Taichung (TW)

(21) Appl. No.: 12/149,188

(22) Filed: Apr. 29, 2008

(30) Foreign Application Priority Data
Mar. 7, 2008 (TW) 97108228

(51) Int. Cl. B25B 1/02

(52) U.S. Cl. 269/182

(57) ABSTRACT

A vise quick-release structure for a miter saw includes a base frame and at least one clamp. The clamp can be operated to move to and fro on the base frame, having pillars. The base frame has through holes each having portions having different widths. The pillars are inserted into the portions of the through holes respectively, whereby the clamp can only be forced to move to and fro in the portions of the through holes, such that the clamp can be quickly detached and installed with respect to the base frame.

### BACKGROUND OF THE INVENTION

1. Field of the Invention

The present invention relates generally to a miter saws, and more particularly, to a vise quick-release structure for a miter saw.

2. Description of the Related Art

Referring to FIG. 13, a vise 100 of a conventional miter saw 110 includes a fixture 101, a screw rod 103 inserted through the fixture 101, a first vising member 102, and a second vising member 104 mounted to a front end of the screw rod 103. The fixture 101 provides a strong point for the whole vise 100. The screw rod 103 is controllably turned clockwise or counterclockwise to drive the second vising member 104 to move close to or away from the first vising member 102. The fixture 101 can be screwingly fixed to a bench 111 of the miter saw 110 by means of at least two screw bolts 105. In this way, the fixture 101 can be though fixed, but when the miter saw 110 is moved or encased for delivery, a user usually must remove the two screw bolts 105 by tool before detaching the fixture 101 from the bench 111 for further convenient delivery of the miter saw 110 or separate encasement of the parts for reduced size of the encasement. Therefore, the way to fix the fixture 101b the screw bolts 105 only brings inconvenience for the detachment and installation of the fixture 101 from and into the bench 111.

### SUMMARY OF THE INVENTION

The primary objective of the present invention is to provide a vise quick-release structure for a miter saw, which enables the user to quickly install and detach the vise and which facilitates delivery and convenient encasement of the miter saw to reduce the size of the encasement.

The foregoing objective of the present invention is attained by the vise quick-release structure for the miter saw. The vise quick-release structure includes a base frame, at least one clamp, at least one bar-shaped member, and at least one vising member. The base frame is located at a bottom side of the miter saw, having at least one position and release set, which has two through holes. Each of the through holes defines an install portion and a retain portion. Each of the retain portions is less wide than the install portion. The clamp includes a fixture and two pillars connected with a bottom side of the fixture. Each of the pillars passes through the corresponding through hole and has a head portion formed at a free end thereof. The diameter of the head portion is defined between the widths of the install portion and the retain portion. The fixture can be forced for movement between a first position and a second position. When the fixture is located at the first position, the two pillars are located at the install portion. When the fixture is located at the first position, the two pillars are located at the install portion. When the fixture is located at the second position, the two pillars are located at the retain portion and the head portions are engaged with the retain portion. The bar-shaped member is inserted through the fixture. The vising member is connected with one end of the bar-shaped member. Accordingly, the clamp can be quickly released from or installed onto the base frame, thus facilitating the delivery of the whole miter saw or the separate encasement of the parts.

### BRIEF DESCRIPTION OF THE DRAWINGS

FIG. 1 is a perspective view of the miter saw in accordance with a preferred embodiment of the present invention.

FIG. 2 is an exploded view of the preferred embodiment of the present invention.

FIG. 3 is an enlarged view taken from A indicated in FIG. 2, illustrating the convex portions.

FIG. 4 is a top view of the preferred embodiment of the present invention.

FIG. 5 is a schematic view of a part of the preferred embodiment of the present invention, illustrating that the stopping member is inserted into the slot.

FIG. 6 is similar to FIG. 5, illustrating that the stopping member is inserted into the slot.

FIG. 7 is a sectional view taken from a line 7-7 indicated in FIG. 4, illustrating that the clamp is engaged with the base frame.

FIG. 8 is similar to FIG. 7, illustrating that the clamp is moved to the install portion.

FIG. 9 is similar to FIG. 7, illustrating that the clamp is released from the base frame.

FIG. 10 is similar to FIG. 7, illustrating that the fixture and the two pillars are formed in one piece.

FIG. 11 is a sectional view taken from a line 11-11 indicated in FIG. 4, illustrating that the vising member is engaged with the base frame.

FIG. 12 is similar to FIG. 11, illustrating that the vising member is being released from the base frame.

FIG. 13 is a perspective view of the conventional miter saw.

### DETAILED DESCRIPTION OF PREFERRED EMBODIMENTS

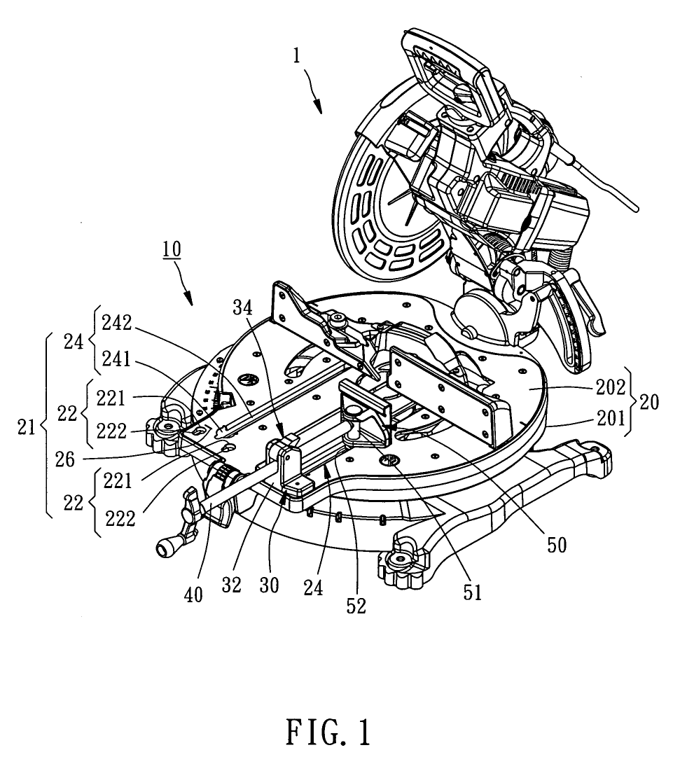

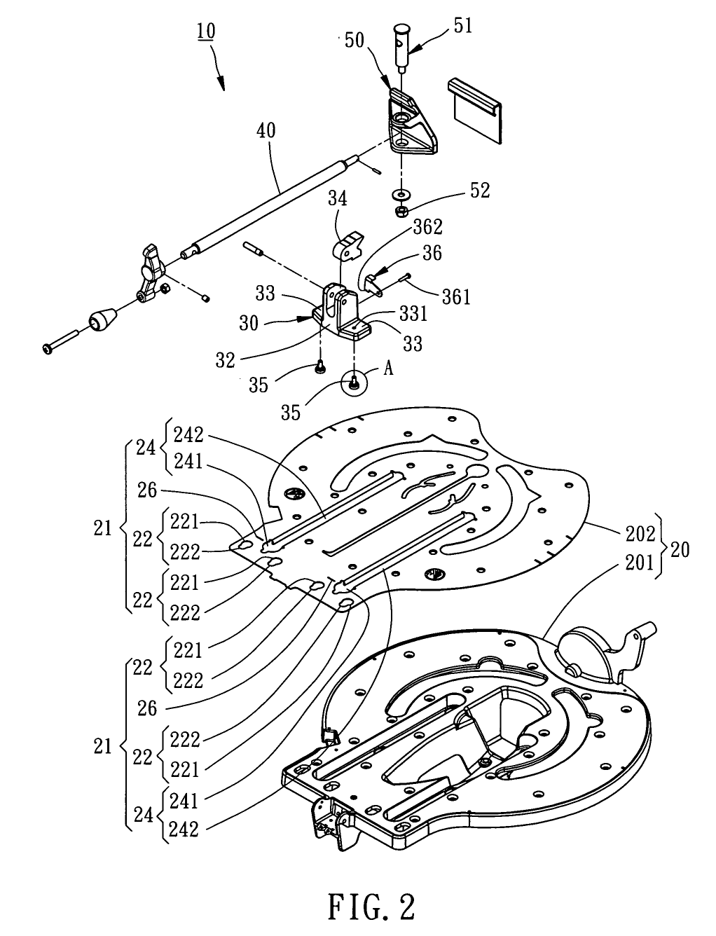

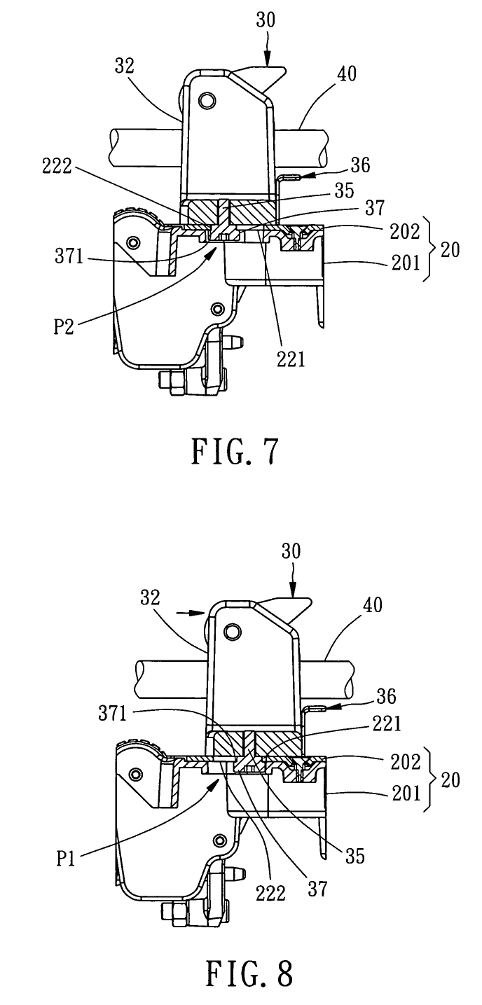

Referring to FIGS. 1-12, a vise quick-release structure 10 for a miter saw 1 in accordance with a preferred embodiment of the present invention is composed of a base frame 20, a clamp 30, two pillars 35, a bar-shaped member 40, and a vising member 50.

The base frame 20 is located at a bottom side of the miter saw 1 and includes a chassis 201 and a plate 202 mounted onto the chassis 201. The plate 202 has two position and release sets 21 for shifting the clamp 30. Each of the position and release sets 21 has two through holes 22, an elongated groove 24, and a slot 26. For the illustrative convenience, the following recitation is based on one of the position and release sets 21. Each of the through holes 22 defines an install portion 221 and a retain portion 22, wherein the install portion 221 is wider than the retain portion 222. Each of the elongated grooves 24 has a release portion 241 and a slide portion 242. The release portion 241 is close to the through hole 22. The slide portion 242 is connected with the release portion 241. The release portion 241 is wider than the slide portion 242. The slot 26 is an elongated hole and located close to the release portion 241.

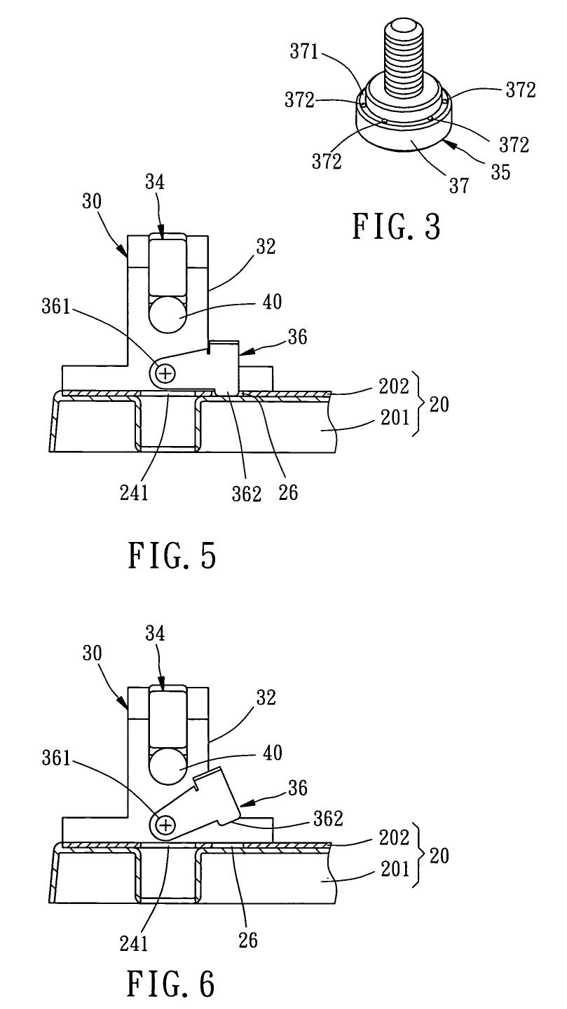

The clamp 30 includes a fixture 32, a gripping member 34, and a stopping member 36. The fixture 32 has two extension parts 33 extending parallel outwards. Each of the extension parts 33 has a threaded hole 331. In this embodiment, each of the two pillars 35 is a screw nut. Each of the screw nuts 35 at one end is screwed into the corresponding threaded hole 331 to be connected with a bottom side of the fixture 32. Each of the screw nuts 35 has a head portion 37 at the other end (free end) thereof. The diameter of the head portion 37 is between the respective widths of the install portion 221 and the retain portion 222. The fixture 32 can be forced to move between a first position P1 and a second position P2. When the fixture 32 is located at the first position P1, as shown in FIG. 8, the two screw bolts 35 are located in the install portions 221 respectively. When the fixture 32 is located at the second position P2, the two screw bolts 35 are located at the retain portions 222 respectively, the head portions 37 being jammed at the retain portions 222. Each of the head portions 37 has a stepped portion 371 in contact with a bottom side of the plate 202 for friction, thus preventing the fixture 2 from random sliding. For more frictional resistance, a plurality of convex portions 372 can be formed on the stepped portion 371 of the head portion 37, as shown in FIG. 3.

The gripping member 34 is pivoted to a top side of the fixture 32. The user can cock/press the gripping member 34 to release/position the bar-shaped member 40 inserted through the fixture 32.

The stopping member 36 has one end pivoted to the fixture 32 via a pin 361, having the other end defined as a stopping portion 362.

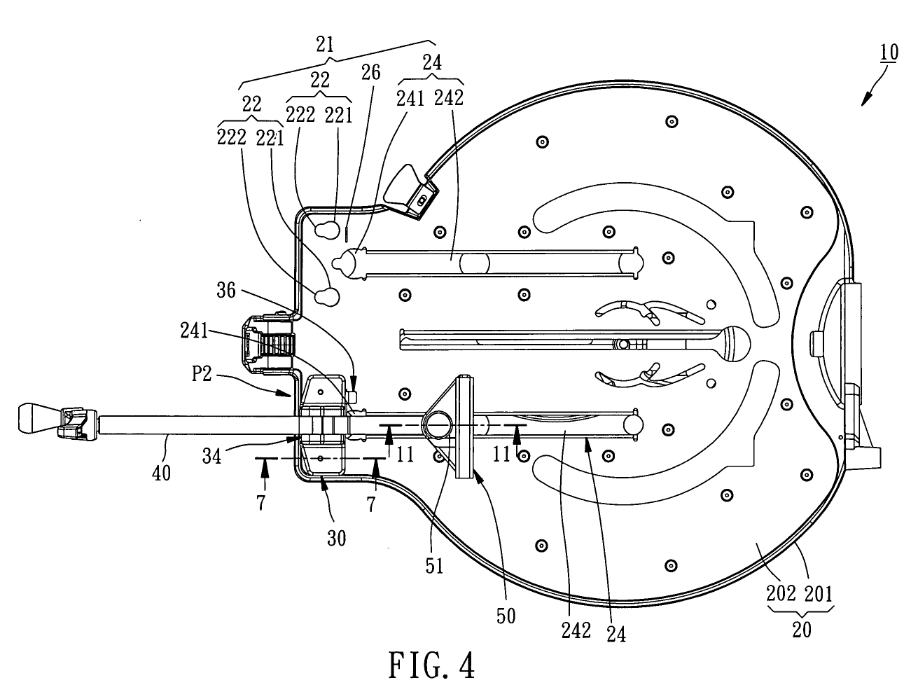

As shown in FIGS. 4 and 5, the clamp 30 is fixed to the base frame 20, and meanwhile, the stopping portion 362 is stopped in the slot 26. In this way, the fixture 32 while forced is still stationary and positioned at the second position P2. The stepped portions 371 of the head portions of the two screw bolts 35 also engage the bottom side of the plate 202, such that the fixture 32 is more positioned.

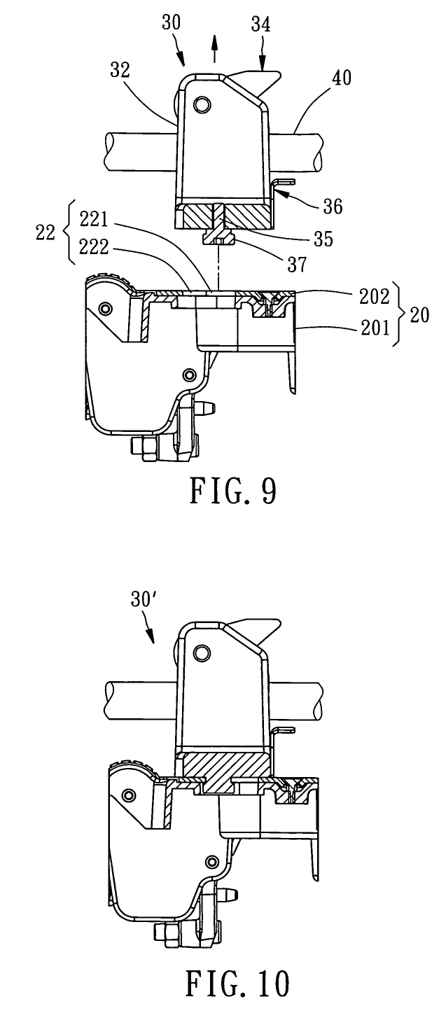

When the user intends to detach the clamp 30 from the base frame 20, the user can first disengage the stopping portion 362 from the slot 26, as shown in FIG. 6. Next, the user can push the fixture 32 from the second position P2 to the first position P1 to enable the two screw bolts 35 to be located at the install portions 221 respectively. In the meantime, the two screw bolts 35 are no longer stopped by the plate 202 to allow taking away the clamp 30 straight because the diameter of the head portion 37 is smaller than the width of the install portion 221. On the contrary, as shown in FIG. 9, when the user intends to install the clamp 30 into the base frame 20, the user can align the screw bolts 35 with the install portions 221 respectively and then insert the screw bolts 35 into the respective install portions 221. Next, the user can push the fixture 32 toward the retain portion 222 to enable the head portions 37 to be jammed at the retain portions 222 again and to enable the stopping portion 362 to be stopped in the slot 26. Finally, the installing operation is completed. Therefore, the present invention provides convenient and quick operation.

As an alternative, the fixture 32 and the two pillars 35 can be formed in one piece as the clamp 30′ shown in FIG. 10. The clamp 30′ can do the same effect as the clamp 30 does.

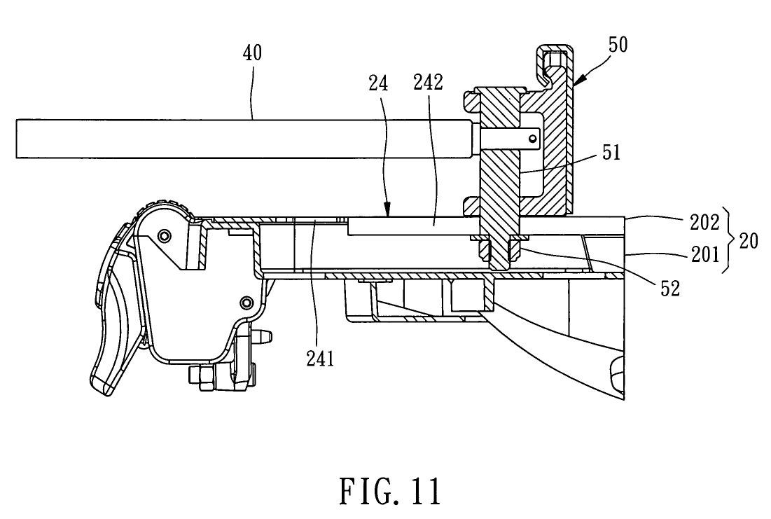

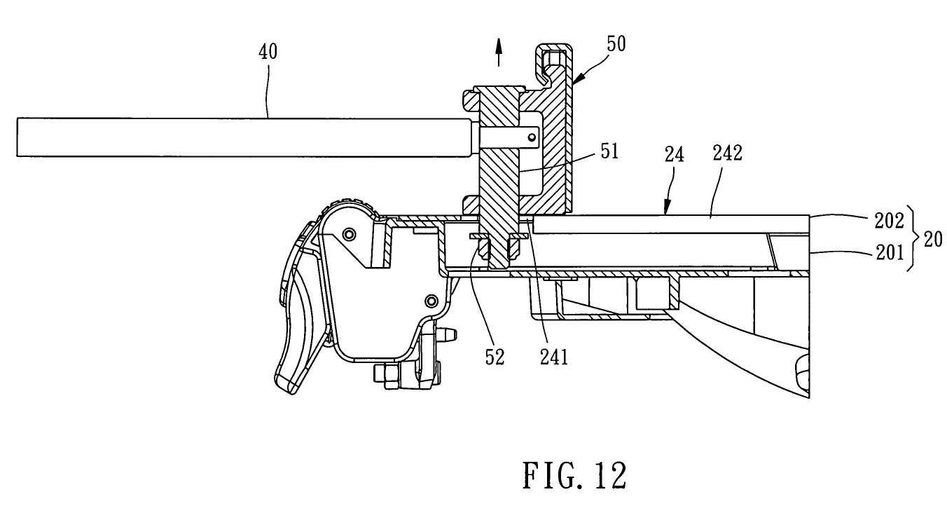

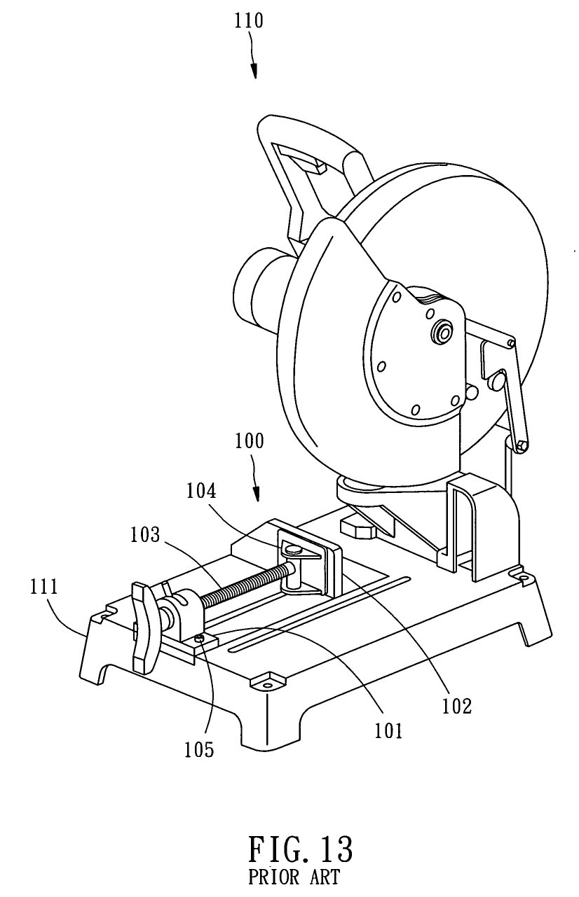

As shown in FIGS. 11-12, the vising member 50 is pivoted to one end of the bar-shaped member 40 in such a way that a pivot bolt 51 is inserted through the vising member 50 to be threaded with a screw nut 52. The screw nut 52 and a bottom part of the pivot bolt 51 are defined as a limiter for preventing the pivot bolt 51 from disengaging from the slide portion 242. The width of the limiter is defined between those of the slide portion 242 and the release portion 241, and the screw nut 52 of the vising member 50 is stopped by the plate 202, such that the vising member 50 located at the slide portion 242 can only slide to and fro transversally along the slide portion 242. When the vising member 50 is moved to the release portion 241, the vising member 50 can be lifted away from the elongated groove 24 to further disengage from the base frame 20 because the screw nut 52 is no longer stopped by the plate 202. Accordingly, the vising member 50 can be quickly detached. As for installing the vising member 50 into the base frame 20, the vising member 50 is first placed on the base frame 20, then the pivot bolt 51 and the screw nut 52 are inserted into the release portion 241, and finally the vising member 50 is moved to the slide portion 242 for completion of the installation.

In conclusion, the vise quick-release structure 10 of the present invention is designed in such a way that the position and release set 21 coordinates with the pillars 35 and the vising member 50 to allow the user's quick detachment and installation of the clamp 30 and the vising member 50 away from and into the base frame 20. Compared with the prior art, the present invention is more convenient for the delivery of the miter saw and the encasement of the parts thereof.

Although the present invention has been described with respect to a specific preferred embodiment thereof, it is no way limited to the details of the illustrated structures but changes and modifications may be made within the scope of the appended claims.

What is claimed is:

1. A vise quick-release structure for a miter saw, comprising:
a base frame located a bottom side of said miter saw and having at least one position and release set, said at least one position and release set having two through holes, each of said through holes defining an install portion and a retain portion, each of said retain portions having a width that is smaller than that of said install portion; and
at least one clamp having a fixture and two pillars connected with a bottom side of said fixture, each of said two pillars being inserted through one said corresponding through hole and having a head portion at a free end thereof, said head portion having a diameter defined between widths of said install portion and said retain portion, said fixture being by force movable between a first position, in which said two pillars are located at said install portions respectively, and a second position, in which said pillars are located at said retain portions respectively and said head portions are stopped at said retain portions respectively.

2. The vise quick-release structure as defined in claim 1, wherein said position and retain set further comprises a slot, and when said stopping portion is stopped in said slot, said fixture is stationary and held at the second position.

3. The vise quick-release structure as defined in claim 1, wherein said fixture comprises two extension parts, each of which has a threaded hole; said pillars are screw bolts each having two ends, one of which is screwed into said corresponding threaded hole and the other end has said head portion.

4. The vise quick-release structure as defined in claim 3, wherein said base frame comprises a plate and a chassis, said plate having said position and release set; each of said head portions of said screw bolts comprises a plurality of convex portions, said convex portions being stopped against a bottom side of said plate of said base frame when said fixture is located at the second position.

5. The vise quick-release structure as defined in claim 1, wherein said fixture and said two pillars are formed in one piece.

6. The vise quick-release structure as defined in claim 1 further comprising at least one bar-shaped member and at least one vising member, said at least one bar-shaped member being inserted through said fixture, said at least one vising member being connected with an end of said bar-shaped member.

7. The vise quick-release structure as defined in claim 6, wherein said vising member is pivoted to said bar-shaped member via a pivot bolt inserted through said vising member, a screw nut being screwed with a bottom part of said pivot bolt to define a limiter, said limiter having a width defined between those of said slide portion and said release portion.
